(19) United States
(12) Patent Application Publication
(10) Pub. No.: US 2006/0227566 A1
(43) Pub. Date: Oct. 12, 2006

(54) Structure of a vehicle lamp

(76) Inventor: Jihn-Shiun Lee, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/099,670

(22) Filed: Apr. 6, 2005

(51) Int. Cl. F21V 11/14; F21V 1/00

(52) U.S. Cl. 362/509; 362/351; 362/361

(57) ABSTRACT

A vehicle lamp includes a shell, a cover joined to the shell, a reflecting shield held in the shell, a bulb secured on a middle portion of the reflecting shield, and a light splitting shield; the cover is pervious to light; the light splitting shield isn't pervious to light, and it has several holes formed thereon; the light splitting shield is arranged between the reflecting shield and the cover such that the lamp will produce light like that emitted from several light emitting diodes when the bulb is powered.

### BACKGROUND OF THE INVENTION

1. Field of the Invention

The present invention relates to a vehicle lamp, more particularly one, which has single bulb, and which has a light-splitting shield formed with many holes and positioned in front of a reflecting shield such that that when the bulb is powered, the lamp will produce light like that emitted from several light emitting diodes.

2. Brief Description of the Prior Art

Conventional lamps on tails of vehicles include a shell, a reflecting shield held in the shell, a bulb secured on the reflecting shield, and a cover, which is pervious to light, and joined to the shell; thus, light will be produced and travel outside the lamp through the cover when the bulb is powered. Such conventional lamps can only produce common visual effects, and they can't satisfy the needs of those people who like modern things.

Therefore, a kind of more modern lamps of vehicles is developed, which is equipped with several light emitting diodes (LED) instead of single bulb. However, such LED lamps have more complicated structure than the above-mentioned lamps. And, it takes more time and labor to assemble the LED lamps because the light emitting diodes have to be fitted on a securing seat separately. Consequently, the manufacturing cost and price of such lamps is relatively high.

### SUMMARY OF THE INVENTION

It is a main object of the invention to provide an improvement on a vehicle lamp to overcome the above-mentioned problem.

The vehicle lamp of the invention includes a shell, a cover joined to the shell, a reflecting shield held in the shell, a bulb secured on a middle portion of the reflecting shield, and a light splitting shield. The cover is pervious to light while the light splitting shield isn't pervious to light, and has several holes thereon. The light splitting shield is disposed between the reflecting shield and the cover such that the lamp will produce light like that emitted from several light emitting diodes when the bulb is powered.

### BRIEF DESCRIPTION OF THE DRAWINGS

The present invention will be better understood by referring to the accompanying drawings, wherein:

FIG. 1 is an exploded perspective view of the first preferred embodiment of a vehicle lamp in the present invention,

FIG. 2 is a vertical section of the first preferred embodiment,

FIG. 3 is a vertical section of the second preferred embodiment, and

FIG. 4 is a front view of the third preferred embodiment.

### DETAILED DESCRIPTION OF THE PREFERRED EMBODIMENTS

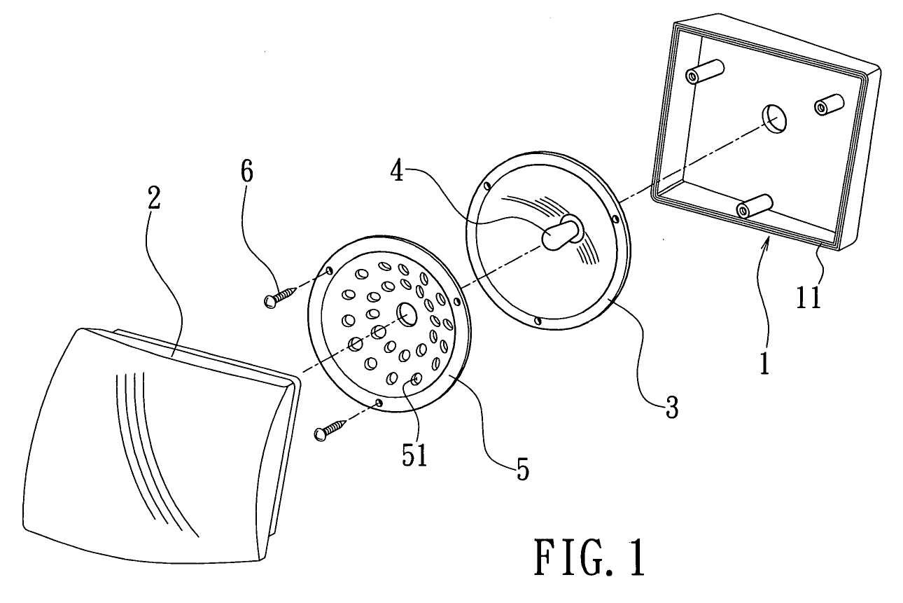

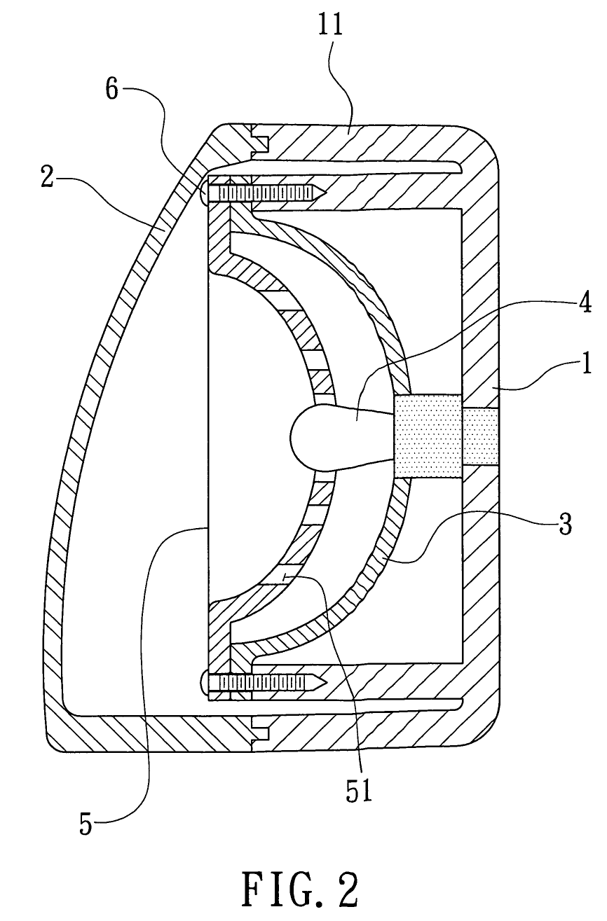

Referring to FIGS. 1 and 2, a first preferred embodiment of a vehicle lamp includes a shell 1, a cover 2, a reflecting shield 3, a bulb 4, and a light-splitting shield 5.

The shell 1 has a loop-shaped protrusion 11 around a holding space thereof. The reflecting shield 3 is held in the shell 1 while the bulb 4 is secured on a middle portion of the reflecting shield 3. The light splitting shield 5 is not pervious to light, and it has many holes 51 formed thereon, which can be round, rectangular or polygonal. The light splitting shield 5 is arranged next to the reflecting shield 3, and screws 6 are first passed through the light splitting shield 5 and the reflecting shield 3, and then connected to the shell 1 such that the light splitting shield 5 and the reflecting shield 3 are secured in position. The cover 2 is pervious to light, and it is positioned over the holding space of the shell 1, and connected to the loop-shaped protrusion 11 of the shell 1.

Thus, when the bulb 4 is powered to produce light, the light will only pass through the holes 51 of the light-splitting shield 5, and in turn the vehicle lamp will produce light like that emitted from several light emitting diodes.

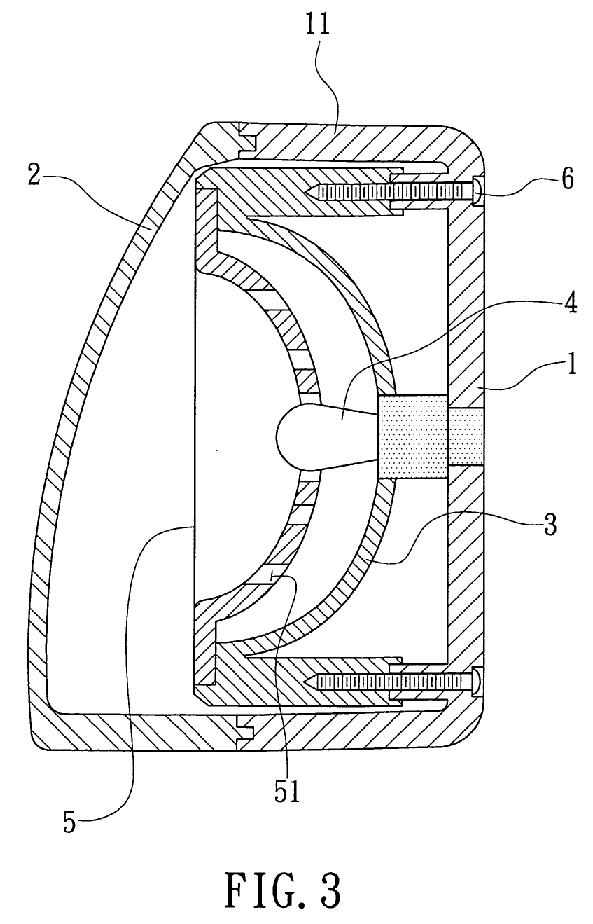

Referring to FIG. 3, alternatively, screws 6 can be first passed through the shell 1, and then connected to the reflecting shield 3 to join the shell 1 and the reflecting shield 3. And, the light splitting shield 5 and the reflecting shield 3 can be connected together by means of high frequency technology.

Furthermore, the light splitting shield 5 can be made in such a color as to match the paint color of the vehicle if the cover 2 is colorless.

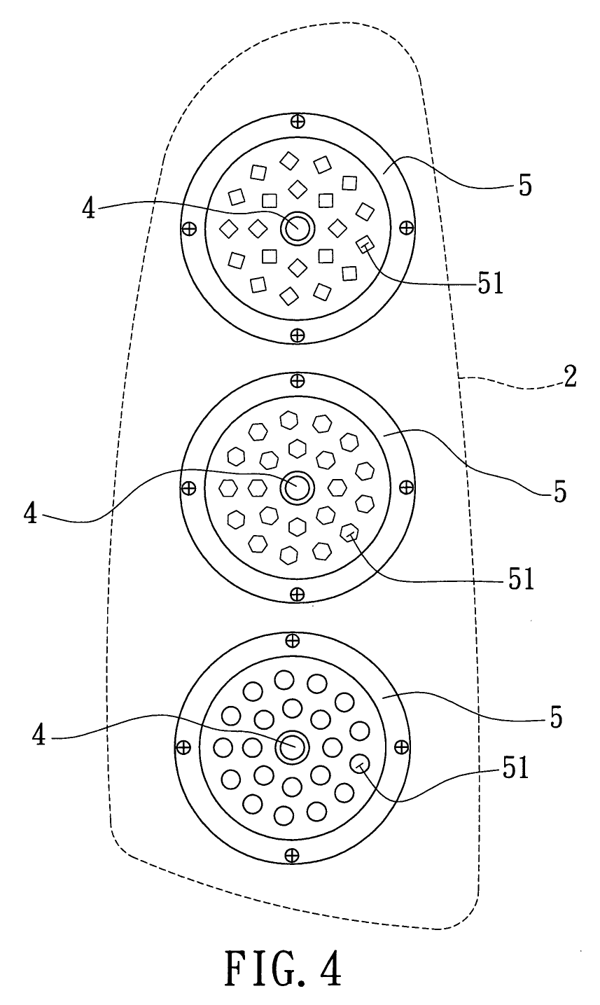

Referring to FIG. 4, a third preferred embodiment of the invention includes a shell, a cover 2, and three lamp units. The cover 2 and the shell are connected together to form a holding room. The lamp units are held in the holding room, and each of them consists of a reflecting shield 3, a bulb 4, and a light-splitting shield 5, which is not pervious to light, and which has many holes 51 formed thereon; the reflecting shield 3 is next to the shell, and the bulb 4 is secured on a middle portion of the reflecting shield 3 while the light splitting shield 5 is arranged next to the reflecting shield 3 to face the cover 2. And, an uppermost one, a middle one, and a lowermost one of the bulbs 4 will produce while light, yellow light, and red light respectively, and an uppermost one, a middle one, and a lowermost one of the lamp units are used as a back-up light, an indicator light, and a brake light of a vehicle respectively.

Or alternatively, all of the three bulbs 4 will produce white light, and an upper portion, a middle portion, and a lower portion of the cover 2 can be made in while color, yellow color, and red color respectively; thus, the uppermost one, the middle one, and the lowermost one of the lamp units can be used as a back-up light, an indicator light, and a brake light of a vehicle respectively.

Although each of the vehicle lamp units of the present invention has single bulb, it can produce light like that emitted from several light emitting diodes. Therefore, the present vehicle lamp has a simpler structure and lower manufacturing cost, and takes less labor and time to assemble when compared with conventional LED vehicle lamps.

What is claimed is:

1. A vehicle lamp, comprising
a shell;
a cover; the cover being pervious to light; the cover being connected to the shell to form a holding space;
a reflecting shield held in the holding space;
a bulb secured on a middle portion of the reflecting shield; and
a light splitting shield; the light splitting shield being not pervious to light; the light splitting shield having a plurality of holes formed thereon; the light splitting shield being arranged between the reflecting shield and the cover.
